(19) United States
(12) Patent Application Publication
(10) Pub. No.: US 2025/0288979 A1
(43) Pub. Date: Sep. 18, 2025

(54) PALLADIUM-FREE ZEOLITE CATALYSTS

(71) Applicant: Washington University, St. Louis, MO (US)

(72) Inventors: Xinhua Liang, St. Louis, MO (US); Kaiying Wang, St. Louis, MO (US)

(21) Appl. No.: 19/075,872

(22) Filed: Mar. 11, 2025

Related U.S. Application Data
(60) Provisional application No. 63/564,145, filed on Mar. 12, 2024.

(51) Int. Cl. B01J 29/70; B01J 37/04; B01J 37/18; C10L 3/12

(52) U.S. Cl. CPC B01J 29/7007; B01J 29/7057; B01J 37/04; B01J 37/18; C10L 3/12; B01J 2229/37

(57) ABSTRACT

Described herein are zeolite catalysts, methods of producing same, and methods of using same. The zeolite catalysts are particularly useful for producing liquefied petroleum gas (LPG).

### CROSS-REFERENCE TO RELATED APPLICATIONS

This application claims priority to U.S. Provisional Application Ser. No. 63/564,145, filed on Mar. 12, 2024, the content of which is hereby incorporated by reference in its entirety.

### STATEMENT REGARDING FEDERALLY SPONSORED RESEARCH & DEVELOPMENT

This invention was made with government support under DE-FE0031909 awarded by the U.S. Department of Energy (DOE). The government has certain rights in the invention.

### FIELD OF THE DISCLOSURE

The field of the disclosure relates generally to zeolite catalysts, including beta (β)-zeolite, H-SSZ-13, SAPO-17, SAPO-18, SAPO-34, SAPO-35, SAPO-56, DNL-6, metal (Me)-modified SAPO-34 (Me=K, Ca, Na, Mg, Al, Ba, Sr, V, Cr, Ti, Mo, Zn, La, Ce, Co, Mn, Fe, Cu, Ni), H-ZSM-5, and H-ZSM-39 catalysts, methods of producing same, and methods of using same. The zeolite catalysts are particularly useful for producing liquefied petroleum gas (LPG).

### BACKGROUND

Liquefied petroleum gas (LPG), with main components of propane and butane, is one of the most important high quality household fuels and also an excellent fuel for spark ignition engines, which can be a replacement for aerosol propellants and refrigerants in place of fluorocarbons. LPG has a huge market, which is projected to grow from $129.17 billion in 2021 to $211.96 billion in 2028 at a CAGR of 7.3% in forecast period. The market is surging due to expanding residential and commercial applications, the transition towards cleaner energy sources, government initiatives, and the versatility of LPG, driving market growth. The global LPG production is ˜330 million tons in 2022. LPG is an economically efficient, cooking energy solution already used by over 2.5 billion people worldwide.

The synthesis of LPG from CO₂ hydrogenation represents a promising approach to simultaneously decrease CO₂ emissions while transforming this greenhouse gas into commercially valuable products. Generally, two primary routes have been explored: the direct Fischer-Tropsch synthesis pathway and the methanol-intermediate pathway. The latter is more promising since it easily breaks the Anderson-Schulz-Flory distribution limitations and achieves higher selectivity towards target products owing to the significant shape-selectivity imposed by the zeolite component of the bifunctional catalysts. Consequently, extensive efforts have focused on developing highly active metal oxide/zeolite composite catalysts, where methanol is initially produced on the metal oxide sites and subsequently converted to hydrocarbons over the zeolite in a single reactor. As methanol synthesis via CO₂ hydrogenation is thermodynamically limited, the immediate conversion of methanol to hydrocarbons can shift the equilibrium and circumvent this constraint.

Untreated zeolite, including β-zeolite, typically demonstrates a poor performance for LPG synthesis, especially under mild temperature and pressure conditions. Previous works have introduced palladium modification of β-zeolite to enhance its low temperature/pressure activity, attributing the improvements to a hydrogen spillover effect of the palladium. However, palladium is expensive.

Thus, there is a need for improved catalysts for LPG production.

### BRIEF DESCRIPTION OF THE DISCLOSURE

In one aspect, the present disclosure is directed to a catalyst comprising: a zeolite selected from the group consisting of beta(β)-zeolite, H-SSZ-13, SAPO-17, SAPO-18, SAPO-34, SAPO-35, SAPO-56, DNL-6, metal (Me)-modified SAPO-34, K-modified SAPO34, Ca-modified SAPO34, Na-modified SAPO34, Mg-modified SAPO34, Al-modified SAPO34, Ba-modified SAPO34, Sr-modified SAPO34, V-modified SAPO34, Cr-modified SAPO34, Ti-modified SAPO34, Mo-modified SAPO34, Zn-modified SAPO34, La-modified SAPO34, Ce-modified SAPO34, Co-modified SAPO34, Mn-modified SAPO34, Fe-modified SAPO34, Cu-modified SAPO34, Ni-modified SAPO34, H-ZSM-5, H-ZSM-39 catalyst, and combinations thereof. The zeolite comprises a greater quantity of strong acid sites than weak acid sites.

In another aspect, the present disclosure is directed to a method of preparing a catalyst, the method comprising: treating a catalyst comprising a zeolite with an acid. The zeolite is selected from the group consisting of beta(β)-zeolite, H-SSZ-13, SAPO-17, SAPO-18, SAPO-34, SAPO-35, SAPO-56, DNL-6, metal (Me)-modified SAPO-34, K-modified SAPO34, Ca-modified SAPO34, Na-modified SAPO34, Mg-modified SAPO34, Al-modified SAPO34, Ba-modified SAPO34, Sr-modified SAPO34, V-modified SAPO34, Cr-modified SAPO34, Ti-modified SAPO34, Mo-modified SAPO34, Zn-modified SAPO34, La-modified SAPO34, Ce-modified SAPO34, Co-modified SAPO34, Mn-modified SAPO34, Fe-modified SAPO34, Cu-modified SAPO34, Ni-modified SAPO34, H-ZSM-5, H-ZSM-39 catalyst, and combinations thereof. The treated catalyst comprises a greater quantity of strong acid sites than weak acid sites in the zeolite.

In still another aspect, the present disclosure is directed to a method of using a catalyst comprising: a zeolite selected from the group consisting of beta(β)-zeolite, H-SSZ-13, SAPO-17, SAPO-18, SAPO-34, SAPO-35, SAPO-56, DNL-6, metal (Me)-modified SAPO-34, K-modified SAPO34, Ca-modified SAPO34, Na-modified SAPO34, Mg-modified SAPO34, Al-modified SAPO34, Ba-modified SAPO34, Sr-modified SAPO34, V-modified SAPO34, Cr-modified SAPO34, Ti-modified SAPO34, Mo-modified SAPO34, Zn-modified SAPO34, La-modified SAPO34, Ce-modified SAPO34, Co-modified SAPO34, Mn-modified SAPO34, Fe-modified SAPO34, Cu-modified SAPO34, Ni-modified SAPO34, H-ZSM-5, H-ZSM-39 catalyst, and combinations thereof, wherein the zeolite comprises a greater quantity of strong acid sites than weak acid sites. The method comprises: receiving a reactant at the catalyst; and reacting the reactant to form a product.

### BRIEF DESCRIPTION OF THE DRAWINGS

FIG. 1 depicts a schematic of an experimental set up for one-step synthesis of LPG from CO₂ and H₂ in accordance with the present disclosure.

FIG. 2 depicts the actual Pd loading with different target Pd loading values and different HNO₃ concentrations during ion exchange in accordance with the present disclosure.

FIG. 3 depicts x-ray diffraction (XRD) results of untreated and ion exchange treated β-zeolite with different concentrations of HNO₃ in accordance with the present disclosure. In all ion-exchanged samples, the nominal Pd loading was fixed at 0.1 wt. %.

FIG. 4A depicts a low-resolution transmission electron microscopy (TEM) image of Pd modified β-zeolite (0.45 wt. % Pd based on inductively coupled plasma mass spectrometry (ICP-MS) analysis) in accordance with the present disclosure.

FIG. 4B depicts a high-resolution transmission electron microscopy (TEM) image of Pd modified β-zeolite (0.45 wt. % Pd based on inductively coupled plasma mass spectrometry (ICP-MS) analysis) in accordance with the present disclosure.

FIG. 4C depicts a high-angle-annular dark-field (HAADF) scanning transmission electron microscopy (STEM) image of Pd modified β-zeolite (0.45 wt. % Pd based on inductively coupled plasma mass spectrometry (ICP-MS) analysis) in accordance with the present disclosure.

FIG. 4D depicts the distribution of Pd nanoparticles based on the images of FIGS. 4A-4C in accordance with the present disclosure.

FIG. 5A depicts a deconvolution of NH₃-TPD profiles for untreated β-zeolite.

FIG. 5B depicts a deconvolution of NH₃-TPD profiles for ion exchanged treated β-zeolite using 0.3 M HNO₃ in accordance with the present disclosure.

FIG. 5C depicts a deconvolution of NH₃-TPD profiles for ion exchanged treated β-zeolite using 0.5 M HNO₃ in accordance with the present disclosure.

FIG. 5D depicts a deconvolution of NH₃-TPD profiles for ion exchanged treated β-zeolite using 1.0 M HNO₃ in accordance with the present disclosure.

FIG. 5E depicts a deconvolution of NH₃-TPD profiles for ion exchanged treated β-zeolite using 0.2 M NaOH in accordance with the present disclosure.

FIG. 5F depicts a deconvolution of NH₃-TPD profiles for 0.2 M NaOH treated β-zeolite further ion exchanged using 0.5 M HNO₃ in accordance with the present disclosure.

FIG. 6 depicts the solid-state ²⁷Al Magic Angle Spinning (MAS) nuclear magnetic resonance (NMR) spectra of untreated and ion exchanged treated β-zeolite using 0.5 M HNO₃ in accordance with the present disclosure.

FIG. 7 depicts pore size distributions of untreated, 0.2 M NaOH and different concentrations of HNO₃ treated β-zeolite in accordance with the present disclosure.

FIG. 8 depicts effects of the Si/Al molar ratio on CO₂ conversion and product yield in accordance with the present disclosure. Reaction conditions include Cu/ZnO/ZrO₂/Al₂O₃ (CZZA): Pd-β=0.5 g: 1 g, GHSV=1200 mL·g⁻¹·h⁻¹, pressure=2 MPa, and temperature=300° C.

FIG. 9 depicts effects of CZZA/Pd-β zeolite mass ratio on CO₂ conversion and product yield in accordance with the present disclosure. Reaction conditions include pressure=2 MPa and temperature=300° C.

FIG. 10 depicts effects of GHSV on CO₂ conversion and product yield in accordance with the present disclosure. Reaction conditions include CZZA: Pd-β=0.5 g: 1 g, pressure=2 MPa, and temperature=300° C.

FIG. 11 depicts a comparison of product yields and CO₂ conversion using different concentrations of HNO₃ treated zeolite in accordance with the present disclosure. Reaction conditions include CZZA: β-zeolite=0.5 g: 1 g, GHSV=1200 mL·g⁻¹·h⁻¹, pressure=2 MPa, and temperature=300° C. For comparison purpose, untreated β-zeolite and the best Pd containing sample 0.3M0.1Pd-β-zeolite were also included.

FIG. 12 depicts LPG synthesis at 260-350° C. under 3 MPa in accordance with the present disclosure. Reaction conditions include CZZA: 0.5M β-zeolite=0.5 g: 1 g, GHSV=1,200 mL·g⁻¹·h⁻¹.

FIG. 13 depicts LPG synthesis using 0.2 M NaOH treated β-zeolite and 0.5 M HNO₃ recovered 0.2 M NaOH treated β-zeolite in accordance with the present disclosure. For comparison purpose, the best sample 0.5 M HNO₃ treated β-zeolite was also included.

FIG. 14 depicts a stability test using CZZA mixed with β-zeolite treated with HNO₃ in accordance with the present disclosure. Reaction conditions include CZZA: β-zeolite=0.5 g: 1 g, GHSV=1,200 mL·g⁻¹·h⁻¹, pressure=2 MPa, and temperature=300° C.

FIG. 15 depicts LPG synthesis for an untreated β-zeolite. The untreated β-zeolite exhibited no LPG production below 340° C.; the LPG yield was only 1.64% at 340° C. and slightly increased to 3.37% at 350° C. Reaction conditions include CZZA: β-zeolite=0.5 g: 1 g, 2.0 MPa pressure and a gas hourly space velocity of 1,200 mL·g⁻¹·h⁻¹, with the temperature varied from 300 to 350° C.

FIG. 16 depicts LPG synthesis using ZnZrO2 mixed with β-zeolite treated with 0.7M HNO₃ in accordance with the present disclosure. Reaction conditions include ZnZrO₂: 0.7 M β-zeolite=0.5 g: 1 g, GHSV=1,200 mL·g⁻¹·h⁻¹, pressure=2 MPa, with the temperature varied from 300 to 400° C.

FIG. 17A depicts LPG synthesis using CZA mixed with untreated H-SSZ-13 zeolite in accordance with the present disclosure. Reaction conditions include CZA: H-SSZ-13 zeolite=0.5 g: 1 g, GHSV=1,200 mL·g⁻¹·h⁻¹, pressure=2 MPa, with the temperature varied from 260 to 350° C.

FIG. 17B depicts LPG synthesis using CZA mixed with 0.5 M HNO₃ treated H-SSZ-13 zeolite in accordance with the present disclosure. Reaction conditions include CZA: 0.5M H-SSZ-13 zeolite=0.5 g: 1 g, GHSV=1,200 mL·g⁻¹·h⁻¹, pressure=2 MPa, with the temperature varied from 260 to 350° C.

### DETAILED DESCRIPTION OF THE DISCLOSURE

The present disclosure demonstrates converting CO₂ to liquefied petroleum gas (LPG) using Cu/ZnO/ZrO₂/Al₂O₃ and zeolite bifunctional catalyst in one reactor at 300° C. and 2

MPa. There are two steps of reactions: converting CO₂ to methanol using Cu/ZnO/ZrO₂/Al₂O₃ catalyst and converting methanol to LPG using acid-treated zeolite catalyst.

Conventionally, the first reaction is equillibrium limited, and the consumption of methanol in the second reaction may shift the first reaction to the right. For the second reaction, palladium-treated zeolite catalyst is conventionally used, and palladium loading is at least 0.1-1 wt. % and the addition of palladium may lower the reaction temperature from 350° C. to 260° C.

In this disclosure, palladium nanoparticles were added to zeolite catalysts by ion exchange in acid solutions with different concentrations. It was surprisingly discovered that the palladium is not the key for the zeolite to convert methanol to LPG. Instead, the addition of acid during palladium loading is the key for the high catalytic performance of Cu/ZnO/ZrO₂/Al₂O₃ and zeolite bifunctional catalyst at temperatures as low as 300° C. Acid treatment changed the ratio of strong acid sites to weak acid sites in zeolite. This is the first disclosure that acid treatment for zeolite catalyst, but not palladium, is the key for converting methanol to LPG. In this disclosure, a stable LPG yield of approximately 19.5% within 100 hours was achieved under relatively mild conditions (300° C. and 2 MPa). This result surprisingly surpasses most previously reported values.

The present disclosure demonstrates that acid may be used to treat zeolite to change the ratio of strong acid sites to weak acid sites in zeolite instead of using costly palladium on zeolite. The acid treated zeolite achieved high catalytic performance at 300° C. and 2 MPa. Without acid treatment, a higher reaction temperature of 350° C. is needed to achieve noticeable amounts of LPG generation. The present disclosure therefore demonstrates a facile and economic method to prepare zeolite catalyst for LPG production, i.e., simply acid treatment, without the addition of palladium.

It is hypothesized that acid redistribution occurs during treatment, thereby modifying the active site distribution. This simple yet effective acid pretreatment not only improves performance but also avoids the substantial costs associated with palladium doping. Overall, this work highlights the importance of acid site tuning, via facile treatment, to optimize zeolite catalytic activity for LPG synthesis.

As used herein, a “strong acid site” is a site that strong enough to protonate hydrocarbons.

As used herein, a “weak acid site” is a site that too weak to protonate hydrocarbons.

In many embodiments, described herein is a catalyst comprising a zeolite comprising a greater quantity of strong acid sites than weak acid sites. That is, the catalyst comprises a zeolite that has more strong acid sites than weak acid sites. As a non-limiting example, in some embodiments the catalyst comprises a zeolite comprising at least 2 strong acid sites and less than at least 2 weak acid sites. In these embodiments, it is understood that any variety and combination of strong acid sites and weak acid sites are present within the zeolite, so long as the number of strong acid sites is a higher number than the weak acid sites.

Generally, the zeolite includes any suitable amount of strong acid sites and weak acid sites that facilitates the catalyst. In some embodiments, the zeolite comprises strong acid sites and weak acid sites in a ratio in a range of from about 1.1:1 to about 1000:1. In some embodiments, the zeolite comprises strong acid sites and weak acid sites in a ratio in a range of from about 1.1:1 to about 100:1. In some embodiments, the zeolite comprises strong acid sites and weak acid sites in a ratio in a range of from about 1.1:1 to about 20:1.

In some embodiments, the catalyst does not comprise rare earth metals. In some embodiments, the catalyst does not comprise palladium. In some embodiments, the catalyst does not comprise platinum. In some embodiments, the catalyst does not comprise rhodium. In some embodiments, the catalyst does not comprise iridium. In some embodiments, the catalyst does not comprise rhodium. In some embodiments, the catalyst does not comprise ruthenium.

In some embodiments, the catalyst comprises a catalyst selected from the group consisting of Cu/ZnO/ZrO₂/Al₂O₃ (CZZA), Cu/ZnO/Al₂O₃ (CZA), Cu/ZnO/ZrO₂ (CZZ), Cu/ZnO, CuZrO₂, In₂O₃, InCeOₓ, InCrOₓ, Ni-Ga, Pd-Ga, Zn-Zr, Mn-Co, and ZnZrO₂, ZnGa₂O₄, ZnAl₂O₄, ZnCr₂O₄, CdZrOₓ, GaZrOₓ, Co-In-Zr, and combinations thereof.

In many embodiments, described herein is a method of preparing a catalyst, the method comprising: treating a catalyst comprising a zeolite with an acid; wherein the treated catalyst comprises a greater quantity of strong acid sites than weak acid sites in the zeolite.

In some embodiments, the acid is selected from the group consisting of strong acids, nitric acid, sulfuric acid, hydrochloric acid, perchloric acid, hydrofluoric acid, phosphoric acid, boric acid, and combinations thereof.

In some embodiments, the acid has a concentration in a range of from about 0.05 M to about 4.0 M. In some embodiments, the acid has a concentration in a range of from about 0.05 M to about 3.0 M. In some embodiments, the acid has a concentration in a range of from about 0.05 M to about 1.0 M. In some embodiments, the acid has a concentration in a range of from about 0.05 M to about 0.5 M.

In many embodiments, described herein is a method of using a catalyst comprising: a zeolite comprising a greater quantity of strong acid sites than weak acid sites; wherein the method comprises: receiving a reactant at the catalyst; and reacting the reactant to form a product.

In some embodiments, the reactant is selected from the group consisting of alcohols, methanol, ethanol, dimethyl ether (DME), C₄ hydrocarbons, C₅ hydrocarbons, C₅₊ hydrocarbons, and combinations thereof.

In some embodiments, the reactant is produced from a catalyzed reaction of a source comprising a gas selected from the group consisting of carbon dioxide (CO₂), carbon monoxide (CO), natural gas, hydrogen (H₂), syngas (mixture of CO and H₂), and combinations thereof.

In some embodiments, the catalyzed reaction comprises a catalyst selected from the group consisting of Cu/ZnO/ZrO₂/Al₂O₃ (CZZA), Cu/ZnO/Al₂O₃ (CZA), Cu/ZnO/ZrO₂ (CZZ), Cu/ZnO, CuZrO₂, In₂O₃, InCeOx, InCrOₓ, Ni-Ga, Pd-Ga, Zn-Zr, Mn-Co, and ZnZrO₂, ZnGa₂O₄, ZnAl₂O₄, ZnCr₂O₄, CdZrOₓ, GaZrOₓ, Co-In-Zr, and combinations thereof.

In some embodiments, the catalyst is reduced prior to reacting the reactant to form a product.

In some embodiments, the product is selected from the group consisting of liquefied petroleum gas (LPG), hydrocarbons, propane, iso-butane, n-butane, iso-pentane, n-pentane, hexane, heptane, and combinations thereof.

In some embodiments, reacting the reactant to form a product occurs at a temperature less than about 400° C. In some embodiments, reacting the reactant to form a product occurs at a temperature less than about 350° C.

In some embodiments, reacting the reactant to form a product occurs at a pressure less than about 8 MPa, less than about 7 MPa, less than about 6 MPa, less than about 5 MPa, less than about 4 MPa, or less than about 3.5 MPa.

In some embodiments, reacting the reactant to form a product occurs at a pressure of at least about 8 MPa, at least about 7 MPa, at least about 6 MPa, at least about 5 MPa, at least about 4 MPa, or at least about 3.5 MPa.

Further aspects of the present disclosure are provided by the subject matter of the following clauses:
1. A catalyst comprising:
a zeolite selected from the group consisting of beta(β)-zeolite, H-SSZ-13, SAPO-17, SAPO-18, SAPO-34, SAPO-35, SAPO-56, DNL-6, metal (Me)-modified SAPO-34, K-modified SAPO34, Ca-modified SAPO34, Na-modified SAPO34, Mg-modified SAPO34, Al-modified SAPO34, Ba-modified SAPO34, Sr-modified SAPO34, V-modified SAPO34, Cr-modified SAPO34, Ti-modified SAPO34, Mo-modified SAPO34, Zn-modified SAPO34, La-modified SAPO34, Ce-modified SAPO34, Co-modified SAPO34, Mn-modified SAPO34, Fe-modified SAPO34, Cu-modified SAPO34, Ni-modified SAPO34, H-ZSM-5, H-ZSM-39 catalyst, and combinations thereof;
wherein the zeolite comprises a greater quantity of strong acid sites than weak acid sites.
2. The catalyst of clause 1, wherein the zeolite comprises strong acid sites and weak acid sites in a ratio in a range of from about 1.1:1 to about 1000:1.
3. The catalyst of clause 1, wherein the zeolite comprises strong acid sites and weak acid sites in a ratio in a range of from about 1.1:1 to about 100:1.
4. The catalyst of clause 1, wherein the zeolite comprises strong acid sites and weak acid sites in a ratio in a range of from about 1.1:1 to about 20:1.
5. The catalyst of clause 1, wherein the catalyst does not comprise rare earth metals.
6. The catalyst of clause 1, wherein the catalyst does not comprise palladium.
7. The catalyst of clause 1, wherein the catalyst comprises a catalyst selected from the group consisting of Cu/ZnO/ZrO₂/Al₂O₃ (CZZA), Cu/ZnO/Al₂O₃ (CZA), Cu/ZnO/ZrO₂ (CZZ), Cu/ZnO, CuZrO₂, In₂O₃, InCeOₓ, InCrOₓ, Ni-Ga, Pd-Ga, Zn-Zr, Mn-Co, and ZnZrO₂, ZnGa₂O₄, ZnAl₂O₄, ZnCr₂O₄, CdZrOₓ, GaZrOₓ, Co-In-Zr, and combinations thereof.
8. A method of preparing a catalyst, the method comprising:
treating a catalyst comprising a zeolite with an acid;
wherein the zeolite is selected from the group consisting of beta(β)-zeolite, H-SSZ-13, SAPO-17, SAPO-18, SAPO-34, SAPO-35, SAPO-56, DNL-6, metal (Me)-modified SAPO-34, K-modified SAPO34, Ca-modified SAPO34, Na-modified SAPO34, Mg-modified SAPO34, Al-modified SAPO34, Ba-modified SAPO34, Sr-modified SAPO34, V-modified SAPO34, Cr-modified SAPO34, Ti-modified SAPO34, Mo-modified SAPO34, Zn-modified SAPO34, La-modified SAPO34, Ce-modified SAPO34, Co-modified SAPO34, Mn-modified SAPO34, Fe-modified SAPO34, Cu-modified SAPO34, Ni-modified SAPO34, H-ZSM-5, H-ZSM-39 catalyst, and combinations thereof;
wherein the treated catalyst comprises a greater quantity of strong acid sites than weak acid sites in the zeolite.
9. The method of clause 8, wherein the acid is selected from the group consisting of strong acids, nitric acid, sulfuric acid, hydrochloric acid, perchloric acid, hydrofluoric acid, phosphoric acid, boric acid, and combinations thereof.
10. The method of clause 8, wherein the acid has a concentration in a range of from about 0.05 M to about 4.0 M.
11. A method of using a catalyst comprising:
a zeolite comprising a greater quantity of strong acid sites than weak acid sites;
wherein the zeolite is selected from the group consisting of beta(β)-zeolite, H-SSZ-13, SAPO-17, SAPO-18, SAPO-34, SAPO-35, SAPO-56, DNL-6, metal (Me)-modified SAPO-34, K-modified SAPO34, Ca-modified SAPO34, Na-modified SAPO34, Mg-modified SAPO34, Al-modified SAPO34, Ba-modified SAPO34, Sr-modified SAPO34, V-modified SAPO34, Cr-modified SAPO34, Ti-modified SAPO34, Mo-modified SAPO34, Zn-modified SAPO34, La-modified SAPO34, Ce-modified SAPO34, Co-modified SAPO34, Mn-modified SAPO34, Fe-modified SAPO34, Cu-modified SAPO34, Ni-modified SAPO34, H-ZSM-5, H-ZSM-39 catalyst, and combinations thereof;
wherein the method comprises:
   receiving a reactant at the catalyst; and
   reacting the reactant to form a product.
12. The method of clause 11, wherein the reactant is selected from the group consisting of alcohols, methanol, ethanol, dimethyl ether (DME), C₄ hydrocarbons, C₅ hydrocarbons, C₅₊ hydrocarbons, and combinations thereof.
13. The method of clause 11, wherein the reactant is produced from a catalyzed reaction of a source comprising a gas selected from the group consisting of carbon dioxide (CO₂), carbon monoxide (CO), natural gas, hydrogen (H₂), syngas (mixture of H₂ and CO), and combinations thereof.
14. The method of clause 13, wherein the catalyzed reaction comprises a catalyst selected from the group consisting of Cu/ZnO/ZrO₂/Al₂O₃ (CZZA), Cu/ZnO/Al₂O₃ (CZA), Cu/ZnO/ZrO₂ (CZZ), Cu/ZnO, CuZrO₂, In₂O₃, InCeOₓ, InCrOₓ, Ni-Ga, Pd-Ga, Zn-Zr, Mn-Co, and ZnZrO₂, ZnGa₂O₄, ZnAl₂O₄, ZnCr₂O₄, CdZrOₓ, GaZrOₓ, Co-In-Zr, and combinations thereof.
15. The method of clause 11, wherein the catalyst is reduced prior to reacting the reactant to form a product.
16. The method of clause 11, wherein the product is selected from the group consisting of liquefied petroleum gas (LPG), hydrocarbons, propane, iso-butane, n-butane, iso-pentane, n-pentane, hexane, heptane, and combinations thereof.
17. The method of clause 11, wherein reacting the reactant to form a product occurs at a temperature less than about 400° C.
18. The method of clause 11, wherein reacting the reactant to form a product occurs at a temperature less than about 350° C.
19. The method of clause 11, wherein reacting the reactant to form a product occurs at a pressure less than about 8 MPa.
20. The method of clause 11, wherein reacting the reactant to form a product occurs at a pressure less than about 3.5 MPa.

### EXAMPLES

Without further elaboration, it is believed that one skilled in the art using the preceding description can utilize the present disclosure to its fullest extent. The following Examples are, therefore, to be construed as merely illustrative, and not limiting of the disclosure in any way whatsoever. It is understood that any numerical range recited herein includes all values from the lower value to the upper value. For example, if a range is stated as 10-50, it is intended that values such as 12-30, 20-40, or 30-50, etc., are expressly enumerated in this specification. These are only examples of what is specifically intended, and all possible combinations of numerical values between and including the lowest value and the highest value enumerated are to be considered to be expressly stated in this application.

### Catalyst Synthesis

Cu/ZnO/ZrO₂/Al₂O₃ (CZZA) is a catalyst with demonstrated high efficiency and stability for methanol synthesis from CO₂ hydrogenation. Consequently, CZZA was utilized herein as the methanol synthesis component. The zeolite serves to subsequently transform the methanol-related intermediates formed on the oxide active sites into hydrocarbons within the confined pores and acidic active sites. Typically, the product distribution over the metal oxide/zeolite composites is closely related to the topological framework and acidity characteristics of the zeolite. Beta (β) zeolite was chosen due to its relatively large pore channels, which, in some embodiments, accommodates sizeable reaction intermediates and enables rapid diffusion of bulky molecular products. Moreover, the facile synthesis of β-zeolite with tunable Si/Al ratios makes it an attractive catalyst constituent for converting methanol.

CZZA was prepared by a co-precipitation method. A certain amount of metal nitrates solution (copper nitrate, zinc nitrate, zirconium nitrate, and aluminum nitrate) were mixed and diluted with deionized (DI) water to a final volume of 500 mL in a volumetric flask. The aqueous solution of mixed metal nitrates and aqueous solution of sodium carbonate (prepared in a 1,000 mL volumetric flask) were simultaneously added dropwise into 400 mL of preheated DI water (65-70° C.) under vigorous stirring at 400 rpm using an overhead mechanical stirrer (CAT-Ing, Germany). The temperature was kept at 65-70° C. and pH value was kept at 6.5-7.0 during the co-precipitation process. The pH value was immediately adjusted to 7.0 by an aqueous solution of sodium carbonate at the end of co-precipitation. Precipitates were then aged for 30 minutes at 70° C. under vigorous stirring at 400 rpm. After aging, the precipitates were filtered under reduced pressure and rinsed several times with 1,000 mL warm DI water (65-70° C.). Next, the catalyst (solid residues from filtration) was dried in an oven at 110° C. overnight then calcined in air at 400° C. for 5 hours with a heating rate of 2° C./min.

The Pd-modified β-zeolite catalysts were synthesized via an ion exchange method using nitric acid (HNO₃) solutions of Pd(NO₃)₂·2H₂O. The parent NH₄-form β-zeolite (Si/Al ratio=38) was first converted to the protonic form by calcination at 550° C. for 4 hours. The ion exchange of Pd into the β-zeolite framework was then performed by contacting the zeolite particles with varying concentrations of HNO₃ solutions at room temperature for 24 hours. The resulting slurries were collected by centrifugation, extensively washed, dried overnight at 100° C., and finally calcined at 500° C. for 4 hours. The Pd-modified β-zeolites were denoted as xMyPd-β-zeolite, where x represents the HNO₃ concentration (M) used during ion exchange and y indicates the theoretical Pd weight loading (wt. %) with certain amount of palladium precursor. For example, 0.3M0.1Pd-β-zeolite was obtained through ion exchange using 0.3 M HNO₃ with a targeted 0.1 wt. % Pd loading. The actual Pd content of each catalyst was quantified by inductively coupled plasma mass spectrometry (ICP-MS). Acid-washed β-zeolite samples without Pd were also synthesized following the same procedure but without Pd(NO₃)₂·2H₂O during ion exchange. These samples were denoted as xM-β-zeolite, where x indicates the HNO₃ concentration (M) used.

### Catalyst Characterization

The specific surface areas of the catalysts were measured by nitrogen adsorption/desorption at −196° C. using a Micromeritics 3Flex adsorption analyzer. Prior to analysis, the samples were degassed at 350° C. for at least 6 h under vacuum conditions.

Surface areas were estimated by the Brunauer-Emmett-Teller (BET) method. Powder X-ray diffraction (XRD) patterns were acquired on a Bruker D8 diffractometer using Cu Kα radiation (wavelength=1.5406 Å) at a scanning rate of 3°/min and a power of 40 kV and 40 mA. The actual Pd metal loadings were determined by ICP-MS using a PerkinElmer NexION 2000 system. Samples were digested using a CEM Mars 6 microwave digestion system prior to ICP-MS analysis. Catalyst morphologies were observed by transmission electron microscopy (TEM) using a JEM-2100F instrument. Ammonia temperature-programmed desorption (NH₃-TPD) was conducted on a Micrometrics AutoChem II 2920 analyzer. The catalyst samples were first pre-treated at 550° C. for 1 hour under helium (He) flow, then cooled to 120° C. and saturated with NH₃ for 30 min. Weakly adsorbed NH₃ was purged using He for 1 hour, then the temperature was linearly increased at 10° C./min while monitoring desorbed NH₃ using a thermal conductivity detector. The solid-state ²⁷Al MAS NMR spectra were recorded with a 400 MHz Bruker AVANCE NEO spectrometer at 104.268 MHz with a π/2 pulse length of 2.5 μs. The recycle delay was 2 s, and the spinning frequency was 4.6 kHz. The ²⁷Al chemical shifts were corrected using Al₂O₃ as the reference.

### Catalytic Performance Evaluation

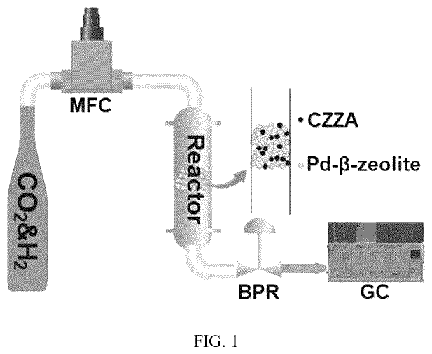

The experimental set-up for the one-step synthesis of LPG from CO₂ and H₂ is illustrated in FIG. 1. The feed flow rates of the CO₂/H₂ reactant mixture were controlled by a mass flow controller (MFC). The reaction pressure was maintained at the desired level using a back pressure regulator (BPR), and the product stream was analyzed using an online gas chromatograph (GC). The gas lines were heated to 180° C. to prevent condensation of products. In a typical catalytic test, 0.5 g of CZZA catalyst and 1 g of β-zeolite were uniformly mixed. Prior to the reaction, the catalyst was reduced at 250° C. for 4 hours under flowing 5% H₂/Ar (30 mL/min) at atmospheric pressure. The feed gas was then switched to a H₂/CO₂ mixture with a 5:1 molar ratio, and the pressure was increased to 2.0 MPa. The reaction temperature was set at 300° C., monitored by a thermocouple inserted into the reactor tube. For the GC analysis, a molecular sieve 5A column was used to analyze Ar, CO, and CH₄, while a Porapak Q column was used to quantify CO₂, methanol, dimethyl ether (DME), and other hydrocarbon products like propane, iso-butane, n-butane, iso-pentane, and n-pentane. No alkene products were detected under the tested reaction conditions. The carbon balance closed around 95%. The CO₂ conversion, product selectivity, and yield were calculated on a molar carbon basis according to the following equations:

$$CO {2}_{c o n v e r s i o n} = \frac{CO {2}_{i n} - CO {2}_{out}}{CO {2}_{i n}} \\ {CnHm}_{s e l e c t i v i t y} = \frac{n C n H m}{CO {2}_{i n} - CO {2}_{out}} \\ {CnHm}_{y i e l d} = CO {2}_{c o n v e r s i o n} * C n H {m}_{sele c t i v i t y}$$

where CO₂ᵢₙ and CO₂ₒᵤₜ are the inlet and outlet amount of CO₂, respectively.

### Results and Discussion

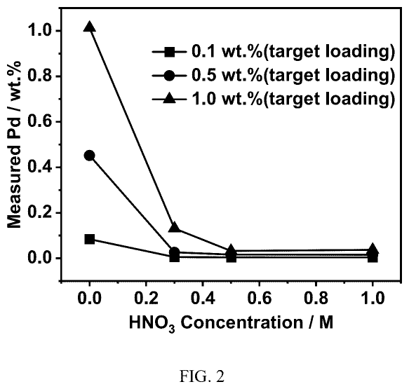

The actual Pd loading of catalysts prepared with different target Pd loadings (i.e., nominal Pd loadings) and different HNO₃ concentrations during ion exchange was determined by ICP-MS, and the results are shown in FIG. 2 and Table 1. Clearly, the actual Pd loading decreased as the HNO₃ concentration used in ion exchange increased from 0 to 0.5 M. With HNO₃ concentrations higher than 0.5 M, there is no further reduction of the actual Pd loading, which remained similar to the loading achieved with 0.5 M HNO₃. For example, with no acid (0 M HNO₃), the catalyst with a nominal 0.5 wt. % Pd loading achieved an actual incorporation of 0.45 wt. % Pd. Increasing the HNO₃ concentration to 0.3 M and 0.5 M during ion exchange reduced the actual Pd loading to 0.026 wt. % and 0.016 wt. %, respectively. Further increasing the acidity to 1 M HNO₃ resulted in an actual Pd loading of 0.015 wt. %, indicating negligible additional impact relative to the 0.5 M HNO₃ level.

TABLE 1
Actual Pd loadings obtained from ICP-MS.

| Pd, wt. % (Targeted loading) | | 0.1 | 0.5 | 1 | |
|---|---|---|---|---|---|
| HNO₃, M | 0.0* | 0.064 | 0.45 | 1.01 | Pd, wt. % |
| | 0.3 | 0.0051 | 0.026 | 0.13 | (ICP-MS) |
| | 0.5 | 0.0043 | 0.016 | 0.032 | |
| | 1.0 | 0.0043 | 0.015 | 0.037 | |

Note:
DI water without the addition of Pd precursor.

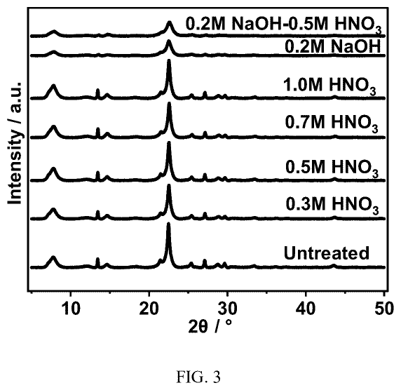

XRD was conducted to characterize the crystal structures of the parent β-zeolite material and the ion-exchanged samples prepared with different HNO₃ concentrations. In all ion-exchanged samples, the nominal Pd loading was fixed at 0.1 wt. %, since a lower Pd loading showed a higher LPG yield based on our previous results. The diffraction patterns in FIG. 3 show the signature β-zeolite peaks at 2θ values of 7.60°, 13.4°, 14.4°, 21.2°, and 22.4°, matching the reference pattern JCPDS PDF-48-0074. No peaks corresponding to Pd species were discerned, due to the low Pd loading. Importantly, the β-zeolite crystalline structure was preserved after ion exchange in an HNO₃ solution at all concentrations examined. This structural integrity was critical for maintaining catalytic activity for LPG synthesis. The XRD results confirmed that the parent zeolite framework remained intact during the ion exchange process in an acid solution. However, when β-zeolite was treated with 0.2 M NaOH, the peak intensity significantly decreased, suggesting the occurrence of partial framework collapse. Further treated with 0.5 M HNO₃ did not recover the crystal structure of this alkali-treated β-zeolite.

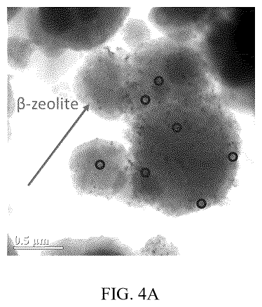

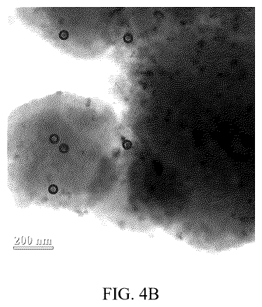

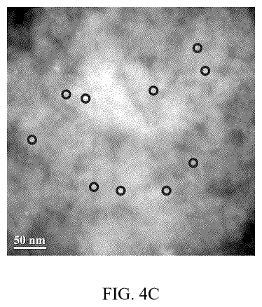

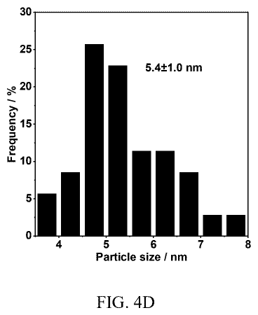

TEM was used to investigate the morphology of the obtained catalysts. Here, a sample with 0.45 wt. % Pd is chosen to facilitate the visualization. FIGS. 4A-4D clearly show the uniform dispersion of Pd nanoparticles across the zeolite support, without significant agglomeration into larger particles. Highlighting representative Pd nanoparticles with red circles enabled visualization of the uniform morphology and dimensions. The average Pd particle size was 5.4±1.0 nm.

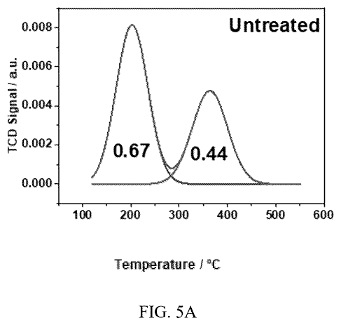

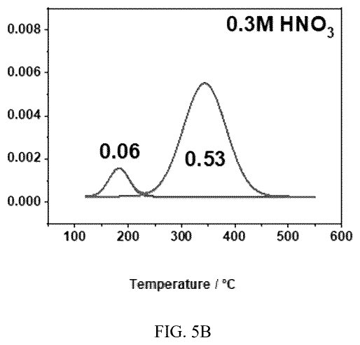

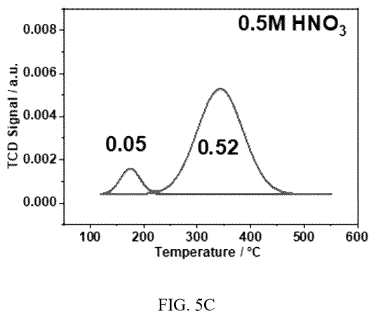

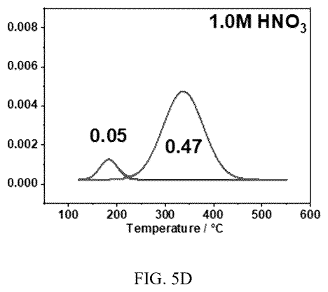

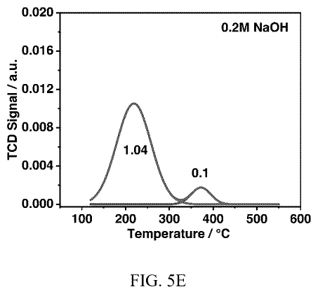

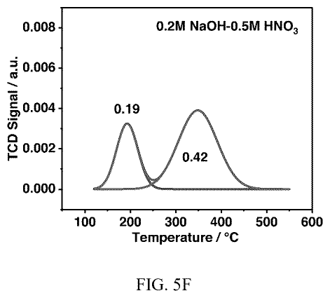

NH₃-TPD was utilized to probe the acid site distributions of the β-zeolite samples before and after palladium incorporation via ion exchange in an HNO₃ solution. Deconvolution of the NH₃-TPD profiles in FIGS. 5A-5F revealed two distinct peaks, centered around 180° C. and 350° C., which can be assigned to weak and strong acid sites, respectively. Quantitative analysis of the peak areas demonstrated that the overall number of acid sites decreased after HNO₃ treatment. Specifically, the weak acid sites were significantly reduced, with the associated peak area dropping from 0.67 in the untreated β-zeolite to 0.06 after ion exchange. In contrast, the population of strong acid sites increased following HNO₃ treatment, with peak areas rising from 0.44 in the parent sample to 0.53, 0.52, and 0.47 after ion exchange with 0.3 M, 0.5 M, and 1 M HNO₃, respectively. These results indicated that while the total acidity decreased, the proportion of remaining strong acid sites was enhanced through the ion exchange process. However, when 0.2 M NaOH was used to treat β-zeolite, the weak acid sites increased to 1.04 while the strong acid sites decreased to 0.1. Further treated with 0.5 M HNO₃ changed the weak acid and strong acid sites to 0.19 and 0.42, respectively.

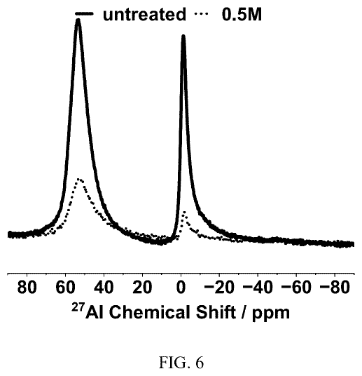

Solid-state ²⁷Al NMR spectroscopy serves as an invaluable tool for elucidating the local environment and coordination state of aluminum species in zeolites. This technique provides critical insights into the effects of acid treatment on aluminum distribution within the zeolite framework. FIG. 6 presents the ²⁷Al MAS NMR spectra of the untreated β-zeolite and its acid-treated counterpart, revealing significant structural changes induced by the acid leaching process. In the spectrum of the untreated β-zeolite, two distinct aluminum environments have been observed: The resonance in the region of 50-60 ppm is assigned to tetrahedrally coordinated framework aluminum species (Al IV). This signal is characteristic of aluminum atoms incorporated into the zeolite framework, which act as the primary source of Brønsted acidity in the material. The Brønsted acid sites arise from the charge compensation when Al³⁺ substitutes for Si⁴⁺ in the framework, typically resulting in a proton associated with an adjacent oxygen atom. The broad resonance in the region of −30 ppm to 20 ppm corresponds to octahedrally coordinated extra-framework aluminum species (Al VI). These extra-framework aluminum (EFAL) species are generally associated with Lewis acidity in zeolites. They can arise from partial dealumination during synthesis or post-synthetic treatments and play a crucial role in modulating the overall acidity. Upon treatment with 0.5 M HNO₃, a marked change was observed in the relative intensities of these resonances. Quantitative analysis through integration revealed that the ratio of framework aluminum (Al (IV)) to extra-framework aluminum (Al (VI)) increased dramatically from 2.16 in the untreated sample to 9.43 in the acid-treated sample. Without being bound to any particular theory, this substantial increase in the Al (IV)/Al (VI) ratio provides compelling evidence for the selective removal of extra-framework aluminum species by mild acid treatment. The preferential removal of EFAL species during mild acid treatment can be attributed to their greater accessibility and reactivity compared to framework aluminum. This selective dealumination process has several important implications for the zeolite's structural and catalytic properties. One significant consequence of this selective removal is the enhancement of Brønsted acidity in the zeolite. As EFAL species are preferentially extracted, the relative concentration of framework aluminum increases. This shift in aluminum distribution translates directly to a higher density of Brønsted acid sites within the zeolite structure. Brønsted acid sites, which arise from the charge-compensating protons associated with framework aluminum, are crucial for many catalytic applications. The increased density of these sites can lead to improved catalytic performance in direct CO₂ to LPG process.

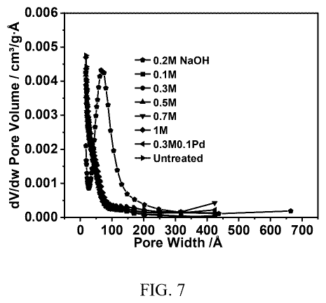

An evaluation of the change in porous structure induced by HNO₃ and NaOH treatment was conducted via N₂ adsorption-desorption analysis at −196° C. As presented in Table 2, the surface area for HNO₃-treated β-zeolite was almost unchanged at approximately 602 m²/g compared to untreated β-zeolite. However, treatment with 0.2 M NaOH decreased the surface area to 461 m²/g. This reduction in surface area was attributable to a decline in micropore area from 405 m²/g in untreated β-zeolite to 254 m²/g in NaOH-treated β-zeolite. A corresponding decrease was also observed in micropore volume from 0.21 m³/g to 0.13 m³/g. Notably, the total pore volume of the NaOH treated sample increased from 0.42 to 0.51 m³/g, indicating the enhanced mesoporosity arose from the micropores. While HNO₃ treatment preserved the microporous structure, a distinct 8 nm mesopore was present in the NaOH treated sample as depicted in FIG. 7. Therefore, treatment of β-zeolite with NaOH led to a transformation of micropores into larger mesopores, evidenced by the decline in micropore surface area and volume concomitant with increases in total pore volume and emergence of an 8 nm mesopore. In contrast, the microporous structure was unchanged following exposure to HNO₃.

TABLE 2
Characteristic N₂ adsorption/desorption data for β-zeolite samples

| | Total Pore | Surface | Micropore | External | Micropore |
|---|---|---|---|---|---|
| Sample | Volume/(cm³/g) | Area/(m²/g) | Area/(m²/g) | Area/(m²/g) | Volume/(cm³/g) |
| Untreated | 0.42 | 602 | 405 | 197 | 0.21 |
| 0.1M HNO₃ | 0.40 | 605 | 408 | 197 | 0.21 |
| 0.3M HNO₃ | 0.42 | 618 | 411 | 207 | 0.21 |
| 0.5M HNO₃ | 0.41 | 609 | 408 | 201 | 0.21 |
| 0.7M HNO₃ | 0.41 | 589 | 388 | 201 | 0.20 |
| 1.0M HNO₃ | 0.42 | 610 | 410 | 200 | 0.21 |
| 0.2M NaOH | 0.51 | 461 | 254 | 207 | 0.13 |

### Catalytic Performances

Ion exchange was performed at varying HNO₃ concentrations with different targeted Pd loadings. The actual Pd loading achieved was dependent on both the HNO₃ concentration and targeted Pd loading. CO₂ conversion and LPG yield results are presented in Table 3. The pure β-zeolite did not produce any LPG under the reaction conditions used. Catalysts prepared using DI water in the ion exchange also did not generate LPG, regardless of Pd loading. The β-zeolite incorporating HNO₃ in the ion exchange process enabled LPG production. Catalysts prepared with a 0.1 wt. % target Pd loading exhibited higher LPG yields, with a maximum of 14.38% obtained using 0.3 M HNO₃ at this targeted loading. This optimal catalyst was selected for subsequent testing.

TABLE 3
CO₂ conversion and LPG yield at varying HNO₃ concentrations during ion exchange of targeted Pd loading (reaction
conditions: CZZA:Pd-β = 0.5 g:1 g, GHSV = 1200 mL · g⁻¹ · h⁻¹, pressure = 2 MPa, and temperature = 300° C.)

| | Pd wt. % (targeted) | | | | | | | | | | | | |
|---|---|---|---|---|---|---|---|---|---|---|---|---|---|
| | 0 | 0.1 | | | | 0.5 | | | | 1 | | | |
| HNO₃, M | 0 | 0 | 0.3 | 0.5 | 1 | 0 | 0.3 | 0.5 | 1 | 0 | 0.3 | 0.5 | 1 |
| Pd, wt. % | 0 | 0.064 | 0.0051 | 0.0043 | 0.0043 | 0.45 | 0.026 | 0.016 | 0.015 | 1.013 | 0.13 | 0.03 | 0.038 |
| (ICP-MS) | | | | | | | | | | | | | |
| CO₂ | 28.84 | 29.87 | 31.87 | 32.07 | 32.31 | 30.43 | 30.47 | 31.78 | 29.81 | 29.45 | 31.91 | 31.14 | 31.11 |
| Conversion, % | | | | | | | | | | | | | |
| LPG yield, % | 0 | 0 | 14.38 | 14.24 | 13.22 | 0 | 10.32 | 10.76 | 10.37 | 0 | 11.31 | 11.04 | 10.66 |

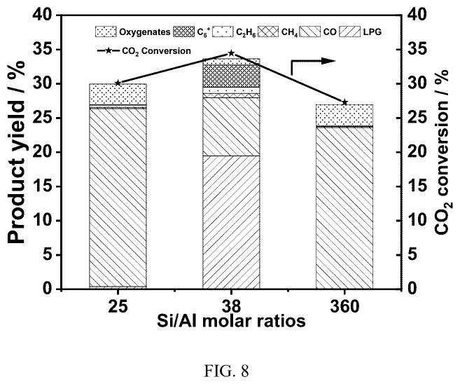

Three-zeolite catalysts with varying Si/Al molar ratios were synthesized to investigate the influence of Si/Al ratio on CO₂ conversion and LPG yield, and the results are shown in FIG. 8. The catalysts were prepared by ion exchange in 0.3 M HNO₃ targeting a 0.1 wt. % Pd loading. The resulting actual Pd loadings were comparable across the three samples. For the catalyst with a Si/Al ratio of 360, a low LPG yield of 5.7% was obtained, while CO was the predominant product with a yield of 17.5%. This sample also exhibited higher oxygenate (methanol+DME) yields compared to the other two catalysts, likely due to the lower concentration of acid sites, which is typical for β-zeolite with higher Si/Al ratios, limiting conversion of methanol/DME into hydrocarbons. The catalyst with a Si/Al ratio of 38 achieved the highest LPG yield at 14.4%. Both CO and oxygenate yields were lower for this sample, compared to the catalyst with a Si/Al ratio of 25.

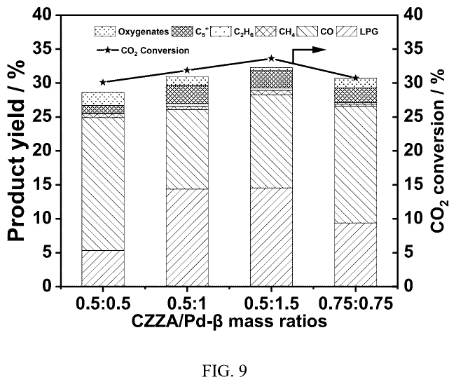

The effects of varying the mass ratio of CZZA to Pd-β zeolite on CO₂ conversion and product yield was investigated, with results presented in FIG. 9. At a fixed CZZA mass of 0.5 g, CO₂ conversion increased with the increasing mass of Pd-β zeolite from 0.5 to 1.5 g. LPG yield similarly rose from 5.3% to 14.4% and reached 14.6% as Pd-β zeolite mass increased from 0.5 to 1.5 g. CO yield was maximized at a 1:1 CZZA/Pd-β zeolite ratio, reaching 19.6% and 17.2% with mass ratios of 0.5:0.5 and 0.75:0.75, respectively. Increased Pd-B zeolite suppressed CO formation and enhanced hydrocarbon yield. Consequently, a CZZA/Pd-β zeolite ratio of 0.5:1 was selected for subsequent experiments.

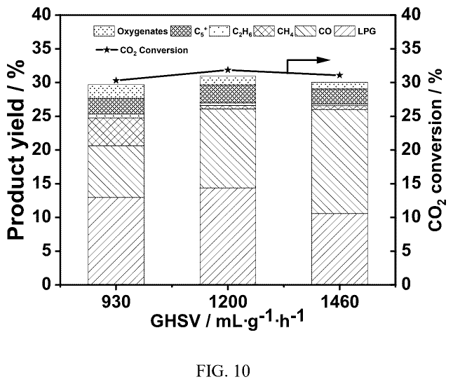

The influence of gas hourly space velocity (GHSV) on CO₂ conversion and product yields was examined, with results presented in FIG. 10. CO yield increased from 7.7% to 11.7% when GHSV raised from 930 to 1,200 mL·g⁻¹·h⁻¹. A further increase to 15.4% CO yield was observed upon increasing GHSV to 1,460 mL·g⁻¹·h⁻¹. At the lowest GHSV of 930 mL·g⁻¹·h⁻¹, methane yield reached 4.2%, exceeding yields achieved at the higher GHSVs of 1,200 and 1,460 mL·g⁻¹·h⁻¹. LPG yield declined with increasing GHSV, with the maximum of 14.4% attained at 1,200 mL·g⁻¹·h⁻¹. Based on these results, a GHSV of 1,200 mL·g⁻¹·h⁻¹ was selected for subsequent experiments to optimize LPG yield.

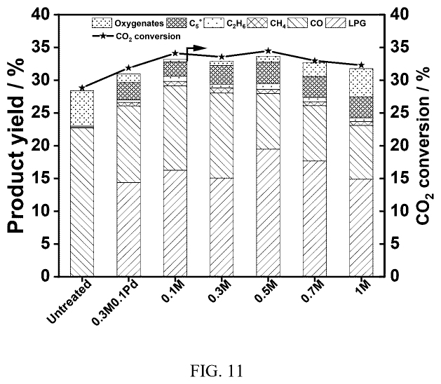

The necessity of acid treatment was further validated by the positive results obtained from the Pd-free samples. Untreated β-zeolite and deionized water treated samples showed no LPG production even at high 1 wt. % Pd concentration under the tested reaction conditions, corroborating previous findings (Table 2). However, β-zeolite treated solely with HNO₃ displayed higher CO₂ conversion and LPG yield compared to Pd-containing analogues. As illustrated in FIG. 11, 0.5 M HNO₃-treated β-zeolite achieved the maximum LPG yield of 19.5%, followed by 0.7 M, 0.1M, and 0.3 M HNO₃ processed samples. In some embodiments, compared to the untreated sample, the enhanced performance of acid-treated samples stems from an increased strong/weak acid site ratio (FIGS. 5A-5D). Weak acid centers predominate in the unmodified sample and were nearly eliminated after exposure to HNO₃. Overall acid site density also declined with post-treatment. The conversion of methanol/DME to hydrocarbons is critically dependent on the acid site concentration of the zeolite. In some embodiments, for samples handled with different HNO₃ concentrations, acid site availability is not the sole determinant governing catalytic activity. In some embodiments, variations in pore size induced by different concentrations of HNO₃, verifiable via BET analysis, also contributes.

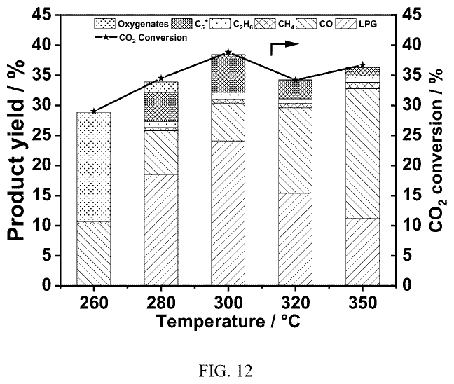

To further optimize reaction parameters, LPG synthesis was examined within a 260-350° C. temperature range under 3 MPa utilizing 0.5 M HNO₃-treated β-zeolite given its superior performance. As evident in FIG. 12, no LPG was produced at temperatures below 300° C. Oxygenates constituted the primary products in this regime. As documented extensively in prior reports, methanol/DME conversion to hydrocarbons employing pure zeolite catalysts proceeds at temperatures exceeding 350° C. In the current study, elevating the temperature to 300° C. under 3 MPa pressure afforded an LPG yield of 22.96%, surpassing that attained under 2 MPa (19.48%). Elevated pressure proved beneficial for improving both CO₂ conversion and LPG yield. When the temperature rose to 320° C., a slight increase in CO₂ conversion was accompanied by a minor reduction in LPG yield, attributable to the reverse water gas shift (RWGS) reaction and associated higher CO selectivity. Upon further increasing the temperature to 350° C., a small increment in CO₂ conversion was overshadowed by a considerable drop in LPG yield to 17.74% due to favorable, endothermic RWGS kinetics at higher temperatures. Consequently, 300° C. was deemed the optimal temperature for CZZA/β-zeolite-catalyzed LPG synthesis.

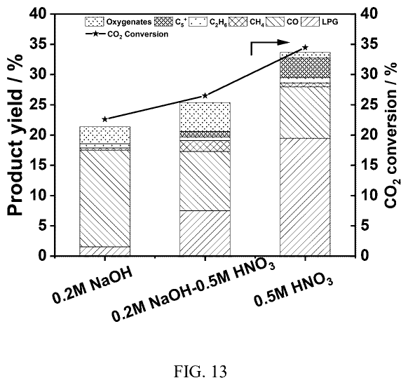

Beta-zeolite possesses a three-dimensional pore network comprising 12-membered ring channels with diameters of 0.76×0.64 and 0.55×0.55 nm. This architecture ensures favorable accessibility of acid sites, high thermal stability, and appreciable acidity. However, in some embodiments, the microporous configuration impedes diffusion rates of chemical species due to narrowly constrained pore sizes, resulting in pre-coke accumulation within micropores that accelerates deactivation. In some embodiments, integrating some mesoporosity further improves LPG yield. Alkaline-mediated removal of Si from the zeolite framework (e.g., via NaOH, tetrapropylammonium hydroxide, tetrabutylammonium hydroxide, Na₂CO₃) represents the simplest and most economical means of effectively introducing mesopores into various zeolite types. Here, β-zeolite is treated with 0.2 M NaOH at 65° C. for 30 minutes. The resulting material underwent three sequential ion exchanges with 1 M NH₄NO3 at 80° C. to obtain the ammonium-form, which was calcinated at 550° C. for 4 hours to produce the proton-type. Employing this NaOH-conditioned β-zeolite for LPG synthesis generated a negligible 1.53% LPG yield as shown in FIG. 13, contrary to expectations. CO₂ conversion was also low at 22.6%. Subsequent processing with 0.5 M HNO₃ marginally improved LPG yield to 7.5% but remained inferior to untreated samples. Therefore, while NaOH treatment may have induced some mesoporosity in β-zeolite, the attendant crystal structure damage apparently outweighed any potential benefits, culminating in poor LPG productivity.

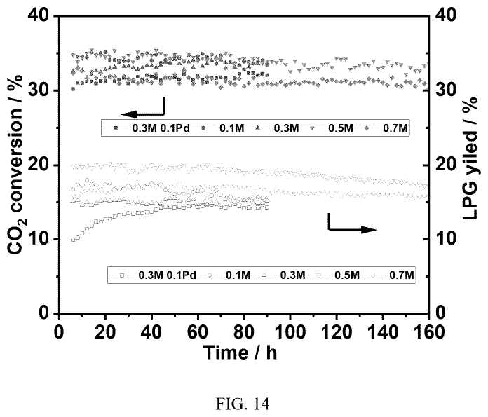

The evolution of CO₂ conversion and LPG yield was monitored, with results presented in FIG. 14. Catalysts with and without Pd incorporation were investigated. Based on prior screening of the effects of HNO₃ concentration and targeted Pd loading, the sample treated with 0.3 M HNO₃ and 0.1 wt. % targeted Pd loading exhibited optimal performance. This Pd-modified sample was compared against catalysts prepared with various HNO₃ treatments but without Pd. As evident in FIG. 14, both CO₂ conversion and LPG yield for the Pd-containing catalyst were lower than the Pd free samples. Regarding LPG yield specifically, for the catalyst with Pd loading, 40 hours were required to achieve a stable catalytic performance; in contrast, only 6 hours were needed for the Pd free samples. Incorporation of Pd on β zeolite appeared to alter the reaction pathway. Regarding stability, the 0.1 M HNO₃-processed catalyst displayed the most rapid deactivation kinetics, likely resulting from heightened acid site availability promoting coke accumulation. The 0.3 M HNO₃-handled sample also exhibited a pronounced decline in LPG yield within the examined 90-hour timeframe. Variants treated with 0.5 M and 0.7 M HNO₃ demonstrated a minor reduction in LPG yield post-reaction, compared to initial values in the tested 90 hours. Hence, these two samples were assessed for an additional 70 hours. After 160 hours on stream, the LPG yield for the 0.5 M HNO₃-exposed sample decreased from 19.88% to 17.12%, while that of the 0.7 M HNO₃-exposed analogue fell from 16.4% to 15.72%. The 0.7 M HNO₃ treated sample demonstrated superior stability, although the 0.5 M HNO₃-treated sample achieved the highest LPG yield over the 160-hour experiment.

### Comparison Without Acid Treatment

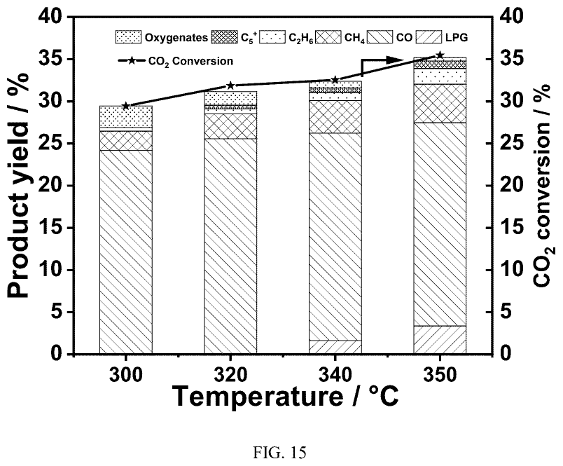

The performance of an untreated β-zeolite and a 0.5 wt. % palladium-modified β-zeolite, which was prepared by ion exchange in deionized water without acid treatment, were also evaluated for LPG production. The testing conditions were 2.0 MPa pressure and a gas hourly space velocity of 1,200 mL·g⁻¹·h⁻¹, with the temperature varied from 300 to 350° C. As shown in the FIG. 15, the untreated β-zeolite exhibited no LPG production below 340° C.; the LPG yield was only 1.64% at 340° C. and slightly increased to 3.37% at 350° C. A similar trend was observed for the 0.5 wt. % Pd-modified zeolite (without acid treatment), with no LPG detected below 330° C. The LPG yield was 1.5% at 330° C. and marginally rose to 4.43% at 350° C. For both catalysts without acid treatment, carbon monoxide yields exceeded 24% under the evaluated reaction conditions. These results indicate that acid treatment is necessary to obtain appreciable LPG yields at 300° C. for this reaction system.

### Comparison with Other Methanol Synthesis Catalysts

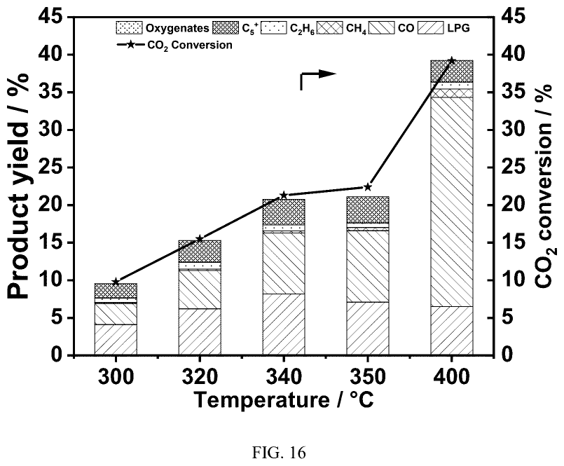

ZnZrO₂ was another widely used catalyst for methanol synthesis. Here a mixture of 0.5 g of ZnZrO₂ and 1.0 g of 0.7 M HNO₃ treated β-zeolite was also evaluated for LPG production. The testing conditions were 2.0 MPa pressure and a gas hourly space velocity of 1,200 mL·g⁻¹·h⁻¹, with the temperature varied from 300 to 400° C. As shown in the FIG. 16, the CO₂ conversion was only 9.8% at 300° C. and the LPG yield was only 4.1%, which was much lower than that obtained from the mixture of CZZA and 0.7 M HNO₃ treated β-zeolite. The maximum LPG yield of 8.2% was obtained at 340° C., with a CO₂ conversion of 21.3%. In the tested conditions, CO was the dominant product, and the content of C₅₊ hydrocarbons was fairly high. This catalyst could therefore be particularly useful for the production of C₅₊ hydrocarbons.

### Application to Other Zeolites

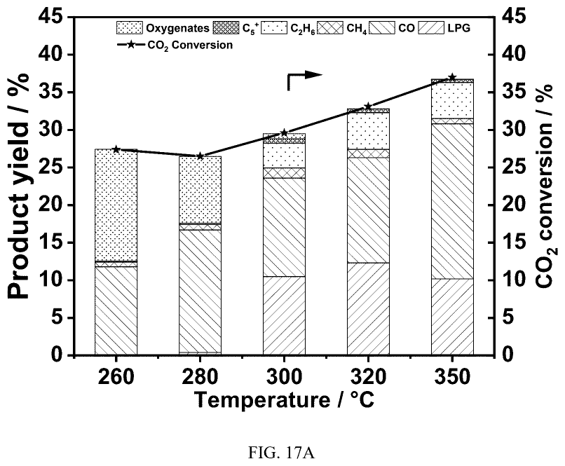

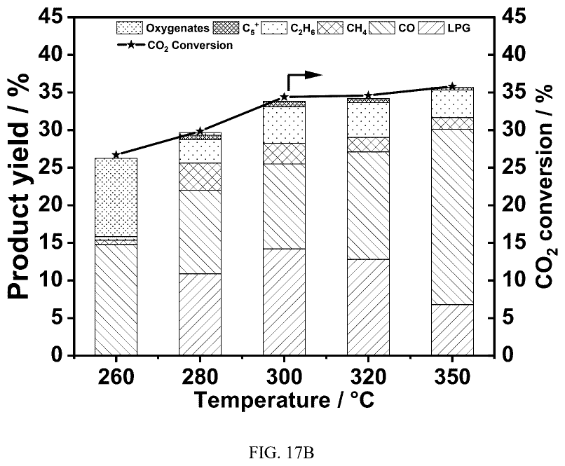

H-SSZ-13 zeolite was evaluated as another zeolite for short chain hydrocarbon production. A mixture of 0.5 g CZA and 1.0 g of either untreated or 0.5 M HNO₃-treated H-SSZ-13 was tested for LPG production under conditions of 2.0 MPa pressure and 1200 mL·g⁻¹·h⁻¹ gas hourly space velocity, with temperatures ranging from 260 to 350° C. The results in FIG. 17A demonstrate that untreated H-SSZ-13 showed no LPG production until reaching 300° C., where it achieved a 10.5% yield. The yield increased to 12.3% at 320° C. but subsequently decreased to 10.2% at 350° C. In contrast, the 0.5 M HNO₃-treated H-SSZ-13 exhibited enhanced catalytic activity as shown in FIG. 17B, producing a 10.9% LPG yield at just 280° C., which exceeded the untreated catalyst's performance at 300° C. The treated catalyst's LPG yield peaked at 14.2% at 300° C. before declining to 12.8% at 320° C. and 6.8% at 350° C. These findings indicate that acid treatment significantly improves the LPG yield for H-SSZ-13 zeolite, similar to the effect observed with beta zeolite. Moreover, the H-SSZ-13 catalyst produced LPG with approximately 89% propane content, which is advantageous for several reasons. Propane's lower boiling point (−42° C.) compared to butane (−0.4° C.) ensures reliable vaporization in cold climates and consistent performance across diverse environmental conditions. Additionally, propane's vapor pressure exceeds that of butane by approximately 400%, resulting in enhanced storage efficiency in pressurized vessels and superior flow characteristics throughout distribution systems. From industrial and commercial perspectives, higher propane concentrations in LPG mixtures provide extended operational capabilities in cold climates, reduced maintenance requirements, and improved energy delivery efficiency, particularly valuable in regions with challenging climatic conditions.

### Conclusions

This disclosure established an efficient and affordable technique to alter zeolite catalysts for optimized LPG synthesis. Through a simple nitric acid treatment of the zeolite, a substantial 19.5% LPG yield was achieved at mild conditions of 300° C. and 2 MPa, obviating the need for costly palladium doping methods prevalent in prior literature. In some embodiments, further increasing the pressure to 3 MPa obtains a 22.96% of LPG yield. The facile acid treatment alone sufficiently tuned the activity and selectivity of the zeolite, avoiding the common palladium doping. Thus, this economically viable preparation route represents a promising strategy for designing high-performance, palladium-free zeolite catalysts for LPG production.

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

To facilitate the understanding of the embodiments described herein, a number of terms are defined below. The terms defined herein have meanings as commonly understood by a person of ordinary skill in the areas relevant to the present disclosure. Terms such as “a,” “an,” and “the” are not intended to refer to only a singular entity, but rather include the general class of which a specific example may be used for illustration. The terminology herein is used to describe specific embodiments of the disclosure, but their usage does not delimit the disclosure, except as outlined in the claims.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that vary depending upon the desired properties sought to be obtained by a particular embodiment. In some embodiments, the numerical parameters are be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein.

In some embodiments, the terms “a” and “an” and “the” and similar references used in the context of describing a particular embodiment (especially in the context of certain of the following claims) are construed to cover both the singular and the plural, unless specifically noted otherwise. In some embodiments, the term “or” as used herein, including the claims, is used to mean “and/or” unless explicitly indicated to refer to alternatives only or to refer to the alternatives that are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and may also cover other unlisted steps. Similarly, any composition or device that “comprises,” “has” or “includes” one or more features is not limited to possessing only those one or more features and may cover other unlisted features.

All methods described herein are performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member is referred to and claimed individually or in any combination with other members of the group or other elements found herein. One or more members of a group are included in, or deleted from, a group for reasons of convenience or patentability. When any such inclusion or deletion occurs, the specification is herein deemed to contain the group as modified thus fulfilling the written description of all Markush groups used in the appended claims.

All of the compositions and/or methods disclosed and claimed herein may be made and/or executed without undue experimentation in light of the present disclosure. While the compositions and methods of this disclosure have been described in terms of the embodiments included herein, it will be apparent to those of ordinary skill in the art that variations may be applied to the compositions and/or methods and in the steps or in the sequence of steps of the method described herein without departing from the concept, spirit, and scope of the disclosure. All such similar substitutes and modifications apparent to those skilled in the art are deemed to be within the spirit, scope, and concept of the disclosure as defined by the appended claims.

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A catalyst comprising:
a zeolite selected from the group consisting of beta(β)-zeolite, H-SSZ-13, SAPO-17, SAPO-18, SAPO-34, SAPO-35, SAPO-56, DNL-6, metal (Me)-modified SAPO-34, K-modified SAPO34, Ca-modified SAPO34, Na-modified SAPO34, Mg-modified SAPO34, Al-modified SAPO34, Ba-modified SAPO34, Sr-modified SAPO34, V-modified SAPO34, Cr-modified SAPO34, Ti-modified SAPO34, Mo-modified SAPO34, Zn-modified SAPO34, La-modified SAPO34, Ce-modified SAPO34, Co-modified SAPO34, Mn-modified SAPO34, Fe-modified SAPO34, Cu-modified SAPO34, Ni-modified SAPO34, H-ZSM-5, H-ZSM-39 catalyst, and combinations thereof;
wherein the zeolite comprises a greater quantity of strong acid sites than weak acid sites.

2. The catalyst of claim 1, wherein the zeolite comprises strong acid sites and weak acid sites in a ratio in a range of from about 1.1:1 to about 1000:1.

3. The catalyst of claim 1, wherein the zeolite comprises strong acid sites and weak acid sites in a ratio in a range of from about 1.1:1 to about 100:1.

4. The catalyst of claim 1, wherein the zeolite comprises strong acid sites and weak acid sites in a ratio in a range of from about 1.1:1 to about 20:1.

5. The catalyst of claim 1, wherein the catalyst does not comprise rare earth metals.

6. The catalyst of claim 1, wherein the catalyst does not comprise palladium.

7. The catalyst of claim 1, wherein the catalyst comprises a catalyst selected from the group consisting of Cu/ZnO/ZrO₂/Al₂O₃ (CZZA), Cu/ZnO/Al₂O₃ (CZA), Cu/ZnO/ZrO₂ (CZZ), Cu/ZnO, CuZrO₂, In₂O₃, InCeOₓ, InCrOₓ, Ni-Ga, Pd-Ga, Zn-Zr, Mn-Co, and ZnZrO₂, ZnGa₂O₄, ZnAl₂O₄, ZnCr₂O₄, CdZrOₓ, GaZrOₓ, Co-In-Zr, and combinations thereof.

8. A method of preparing a catalyst, the method comprising:
treating a catalyst comprising a zeolite with an acid;
wherein the zeolite is selected from the group consisting of beta(β)-zeolite, H-SSZ-13, SAPO-17, SAPO-18, SAPO-34, SAPO-35, SAPO-56, DNL-6, metal (Me)-modified SAPO-34, K-modified SAPO34, Ca-modified SAPO34, Na-modified SAPO34, Mg-modified SAPO34, Al-modified SAPO34, Ba-modified SAPO34, Sr-modified SAPO34, V-modified SAPO34, Cr-modified SAPO34, Ti-modified SAPO34, Mo-modified SAPO34, Zn-modified SAPO34, La-modified SAPO34, Ce-modified SAPO34, Co-modified SAPO34, Mn-modified SAPO34, Fe-modified SAPO34, Cu-modified SAPO34, Ni-modified SAPO34, H-ZSM-5, H-ZSM-39 catalyst, and combinations thereof;
wherein the treated catalyst comprises a greater quantity of strong acid sites than weak acid sites in the zeolite.

9. The method of claim 8, wherein the acid is selected from the group consisting of strong acids, nitric acid, sulfuric acid, hydrochloric acid, perchloric acid, hydrofluoric acid, phosphoric acid, boric acid, and combinations thereof.

10. The method of claim 8, wherein the acid has a concentration in a range of from about 0.05 M to about 4.0 M.

11. A method of using a catalyst comprising:
a zeolite selected from the group consisting of beta(β)-zeolite, H-SSZ-13, SAPO-17, SAPO-18, SAPO-34, SAPO-35, SAPO-56, DNL-6, metal (Me)-modified SAPO-34, K-modified SAPO34, Ca-modified SAPO34, Na-modified SAPO34, Mg-modified SAPO34, Al-modified SAPO34, Ba-modified SAPO34, Sr-modified SAPO34, V-modified SAPO34, Cr-modified SAPO34, Ti-modified SAPO34, Mo-modified SAPO34, Zn-modified SAPO34, La-modified SAPO34, Ce-modified SAPO34, Co-modified SAPO34, Mn-modified SAPO34, Fe-modified SAPO34, Cu-modified SAPO34, Ni-modified SAPO34, H-ZSM-5, H-ZSM-39 catalyst, and combinations thereof;
wherein the zeolite comprises a greater quantity of strong acid sites than weak acid sites;
wherein the method comprises:
receiving a reactant at the catalyst; and
reacting the reactant to form a product.

12. The method of claim 11, wherein the reactant is selected from the group consisting of alcohols, methanol, ethanol, dimethyl ether (DME), C₄ hydrocarbons, C₅ hydrocarbons, C₅₊ hydrocarbons, and combinations thereof.

13. The method of claim 11, wherein the reactant is produced from a catalyzed reaction of a source comprising a gas selected from the group consisting of carbon dioxide (CO₂), carbon monoxide (CO), natural gas, hydrogen (H₂), syngas, and combinations thereof.

14. The method of claim 13, wherein the catalyzed reaction comprises a catalyst selected from the group consisting of Cu/ZnO/ZrO₂/Al₂O₃ (CZZA), Cu/ZnO/Al₂O₃ (CZA), Cu/ZnO/ZrO₂ (CZZ), Cu/ZnO, CuZrO₂, In₂O₃, InCeOₓ, InCrOₓ, Ni-Ga, Pd-Ga, Zn-Zr, Mn-Co, and ZnZrO₂, ZnGa₂O₄, ZnA1204, ZnCr₂O₄, CdZrOₓ, GaZrOₓ, Co-In-Zr, and combinations thereof.

15. The method of claim 11, wherein the catalyst is reduced prior to reacting the reactant to form a product.

16. The method of claim 11, wherein the product is selected from the group consisting of liquefied petroleum gas (LPG), hydrocarbons, propane, iso-butane, n-butane, iso-pentane, n-pentane, hexane, heptane, and combinations thereof.

17. The method of claim 11, wherein reacting the reactant to form a product occurs at a temperature less than about 400° C.

18. The method of claim 11, wherein reacting the reactant to form a product occurs at a temperature less than about 350° C.

19. The method of claim 11, wherein reacting the reactant to form a product occurs at a pressure less than about 8 MPa.

20. The method of claim 11, wherein reacting the reactant to form a product occurs at a pressure less than about 3.5 MPa.
